(19) United States
(12) Patent Application Publication
(10) Pub. No.: US 2013/0175978 A1
(43) Pub. Date: Jul. 11, 2013

(54) BATTERY CHARGING SYSTEM AND METHOD

(71) Applicant: JEN-JUNG HSIAO, Tu-Cheng (TW)

(72) Inventor: JEN-JUNG HSIAO, Tu-Cheng (TW)

(73) Assignee: HON HAI PRECISION INDUSTRY CO., LTD., Tu-Cheng (TW)

(21) Appl. No.: 13/611,096

(22) Filed: Sep. 12, 2012

(30) Foreign Application Priority Data
Jan. 6, 2012 (TW) 101100709

(51) Int. Cl. H02J 7/00

(52) U.S. Cl. 320/107; 320/137; 320/162

(57) ABSTRACT

A battery charging system includes an adapter and a control device. The adapter is connected between an AC voltage source and a battery. The adapted converts the AC voltage source into a DC voltage to charge the battery. The control device is connected to the adapter and the battery. The control device includes a charge-setting module, a charging current control module, and a charging voltage control module, A plurality of different charging modes is stored in the charging setting module. The charging current control module controls a charging current of the adapter charging the battery according to a chosen charging mode. The charging voltage control module controls a charging voltage of the adapter charging the battery according to the chosen charging mode.

### BACKGROUND

1. Technical Field

The present disclosure relates to a battery charging system and method.

2. Description of Related Art

In recent years, portable electronic devices such as cellular phones, laptop computers, and tablet computers, have become widespread. As a result, it has become necessary to include a battery to provide power to the electronic devices. In different working situations, users often have different requirements for the battery. For example, when the battery is installed in an electronic device used in an office, the battery is expected to have a long life and can be charged or recharged many times. When the battery is in other electronic device used in open space, the battery is expected to have a long-staying power and can be used for a long time before being exhausted. However, the battery is often charged in one single mode, and the different expectations of a long working life and a deep power reserves per single use often cannot be satisfied simultaneously.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a battery charging system according to an embodiment, which includes a control device.

FIG. 2 is a block diagram of the control device of FIG. 1.

FIG. 3 is a block diagram of a monitoring module of FIG. 2.

FIG. 4 is flow chart of a battery charging method according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

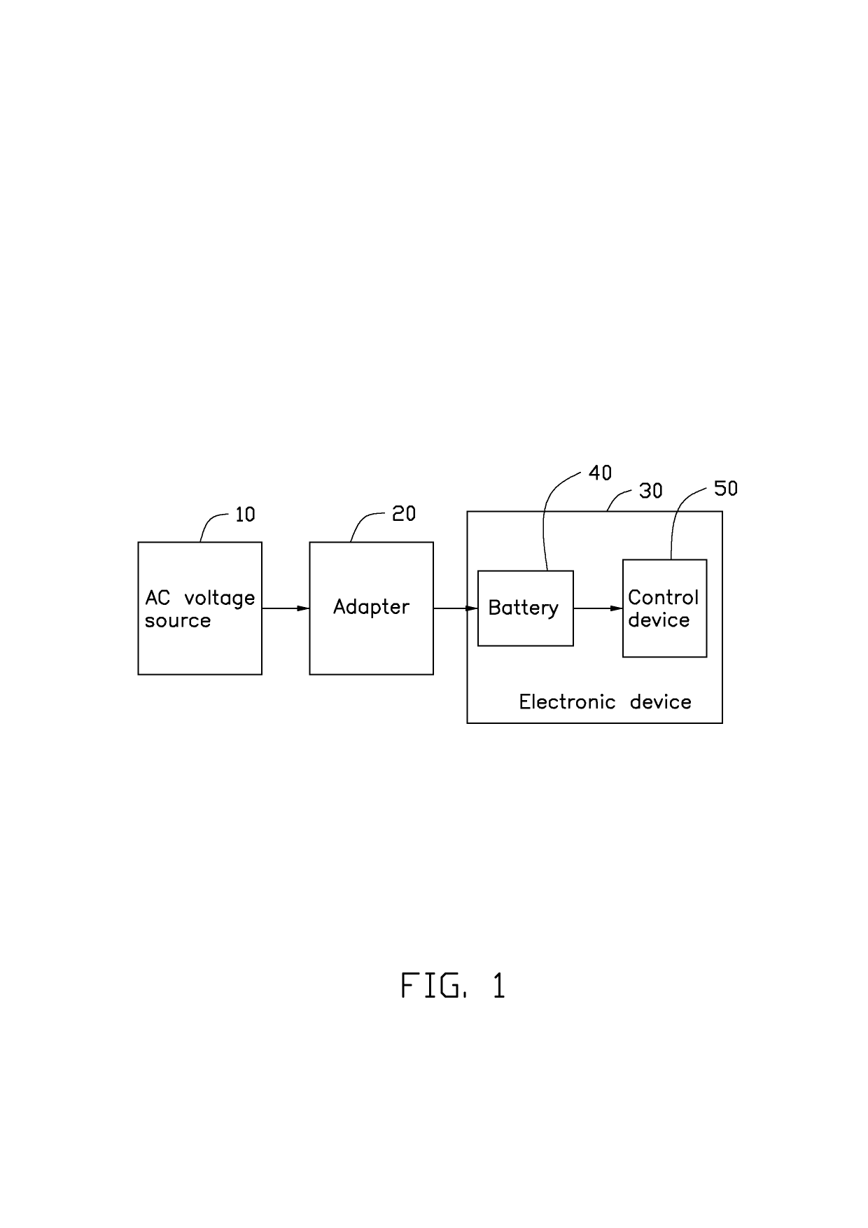

FIG. 1 shows a battery charging system according to an embodiment. The battery charging system includes an alternating current (AC) voltage source 10, an adapter 20, and an electronic device 30. The electronic device 30 includes a battery 40 and a control device 50 mounted therein. The adapter 20 is connected between the AC voltage source 10 and the battery 40. The adapter 20 is configured to receive an AC voltage from the AC voltage source 10, and convert the AC voltage to a direct current (DC) voltage to charge the battery 40. The control device 50 is connected to the battery 40 and the adapter 20. The control device 50 can monitor the battery 40 and control a charging current and a charging voltage of the adapter 20.

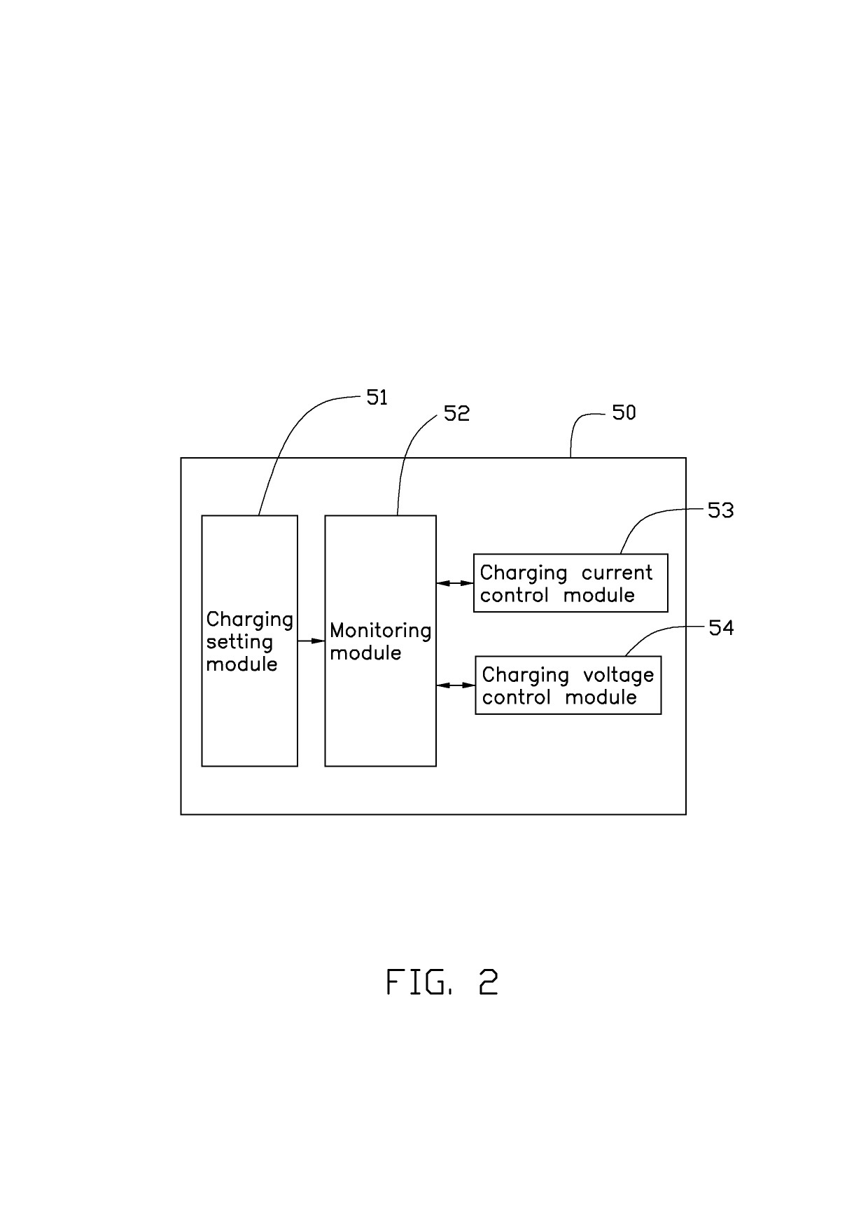

Referring to FIG. 2, the control device 50 includes a charging setting module 51, a monitoring module 52, a charging current control module 53, and a charging voltage control module 54. The charging current control module 53 and the charging voltage control module 54 are connected to the monitoring module 52.

A plurality of parameters of different charging modes are stored in the charging setting module 51. In one embodiment, the charging setting module 51 has three charging modes: a normal charging mode, a long-life charging mode, and a high power charging mode. Under the normal charging mode, the control device 50 controls the adapter 20 to charge the battery 40 with a normal charging voltage and a normal charging current. Under the long-life charging mode, the control device 50 controls the adapter 20 to charge the battery 40 with a first charging voltage and the normal charging current. The first charging voltage is lower than the normal charging voltage. Under the high power charging mode, the control device 50 controls the adapter 20 to charge the battery 40 with the normal charging voltage and a first charging current. The first charging current is less than the normal charging current.

When the adapter 20 charges the battery 40 in the high power charging mode, the first charging current is less, and a trickle charging of the battery 40 is achieved. Therefore, the battery 40 can be saturated with more current than in normal charging mode.

When the adapter 20 charges the battery 40 in the long-life charging mode, the first charging voltage is lower, a voltage drop applied on the battery 40 becomes less and the battery 40 supports a long working life and the ability to function for a large number of recharges.

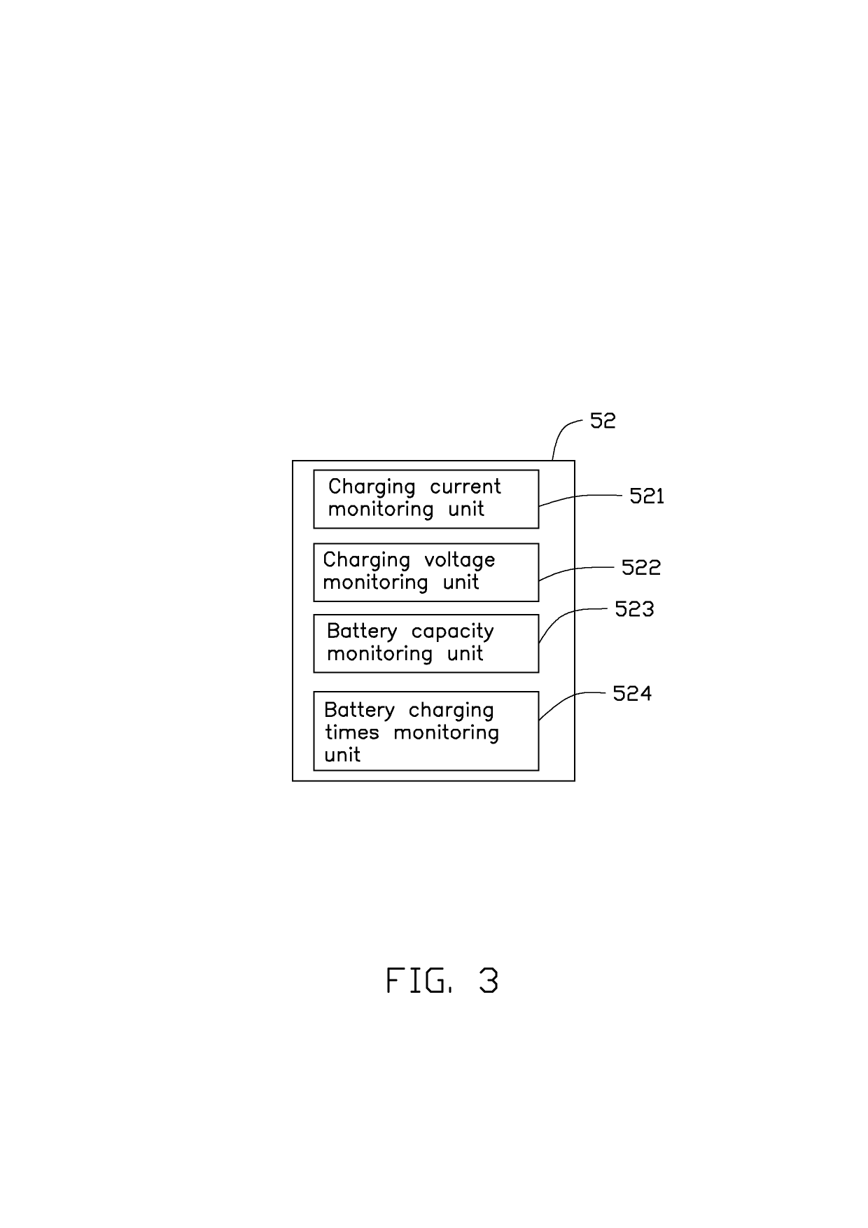

Referring to FIG. 3, the monitoring module 52 includes a charging current monitoring unit 521, a charging voltage monitoring unit 522, a battery capacity monitoring unit 523, and a battery charging times monitoring unit 524. The charging current monitoring unit 521 is used to monitor a charging current of the adapter 20.

When the charging current of the adapter 20 is not equal to a preset charging current (such as the normal charging current or the first charging current), the control device 50 controls the adapter 20 to adjust the charging current. The charging voltage monitoring unit 522 is used to monitor a charging voltage of the adapter 20. When the charging voltage of the adapter 20 is not equal to a preset charging voltage (such as the normal charging voltage or the first charging voltage), the control device 50 controls the adapter 20 to adjust the charging voltage. The battery capacity monitoring unit 523 is used to monitor a power capacity of the battery 40. The battery charging times monitoring unit 524 is used to monitor the number of times the battery 40 is charged or recharged.

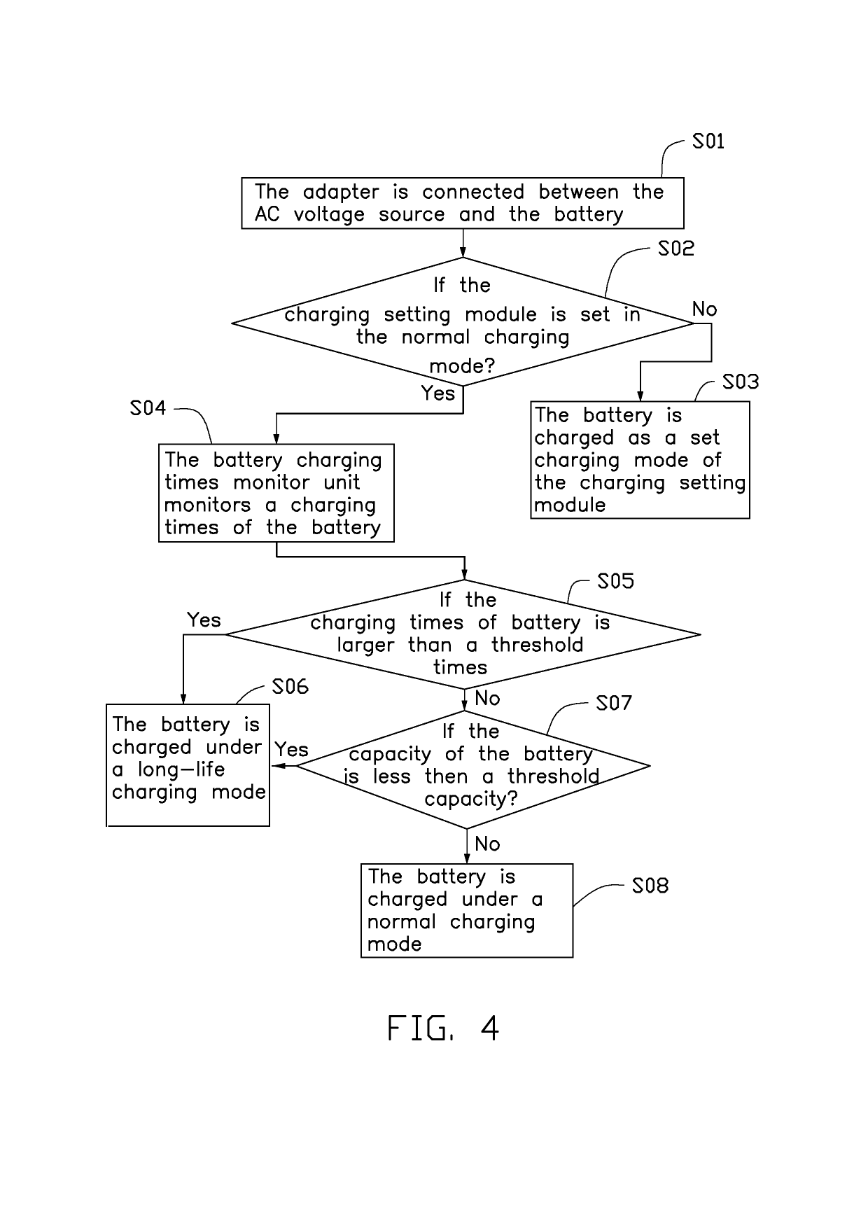

FIG. 4 shows an embodiment of a flow chart of a charging method for a battery, which includes following steps:

In step S01, the adapter 20 is connected between the AC voltage source 10 and the battery 40.

In step S02, the charging setting module 51 is checked to ensure it is set in the normal charging mode. If not, go to step S03, and if yes, go to step S04.

In step S03, the battery 40 is charged according to the preset charging mode of the charging setting module 51.

In step S04, the battery charging times monitor unit 524 monitors the number of times the battery 40 has previously been charged/recharged.

In step S05, check if the number of previous charges/recharges is larger than a threshold times (such as 200 times)? If yes, go to step S06; and if no, go to step S07.

In step S06, the battery 40 is charged under the long-life charging mode.

In step S07, check if the power capacity of the battery 40 is less then a threshold capacity (such as 15000 mAh)? If yes, go to step S06; and if no, go to step S08.

In step S08, the battery 40 is charged under the normal charging mode.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A battery charging system, comprising:
an adapter connected between an alternating current (AC) voltage source and a battery, the adapter converting an AC voltage into a direct current (DC) voltage to charge the battery; and
a control device connected to the adapter and the battery, the control device comprising a charging setting module, a charging current control module, and a charging voltage control module, charging modes stored in the charging setting module, the charging current control module controlling a charging current of the adapter charging the battery according to a chosen charging mode from the charging modes, and the charging voltage control module controlling a charging voltage of the adapter charging the battery according to the chosen charging mode.

2. The battery charging system of claim 1, wherein the charging modes comprises a normal charging mode, and the adapter charges the battery within a normal charging voltage and a normal charging current under the normal charging mode.

3. The battery charging system of claim 2, wherein the charging modes comprises a high power charging mode, the adapter charges the battery within the normal charging voltage and a first charging current under the high power charging mode, and the first charging current is smaller than the normal charging current.

4. The battery charging system of claim 2, wherein the charging modes comprises a long-life charging mode, the adapter charges the battery within a first charging voltage and the normal charging current under the long-life charging mode, and the first charging voltage is smaller than the normal charging voltage.

5. The battery charging system of claim 4, wherein the control device further comprises a monitoring module, the monitoring module comprises a battery capacity monitoring unit, and the battery capacity monitoring unit monitors a power capacity of the battery, and the control device controls the adapter to work in the long-life charging mode when the power capacity of the battery is less than a threshold capacity.

6. The battery charging system of claim 5, wherein the monitoring module further comprises a battery charging times monitoring unit, the battery charging times monitoring unit monitors a number of times the battery has previously been charged, and the control device further controls the adapter to work in the long-life charging mode when the number of times of previous charges is larger than a threshold times.

7. The battery charging system of claim 1, wherein the control device comprises a monitoring module, the monitoring module comprises a charging current monitoring unit, and the charging current monitoring unit monitors the charging current.

8. The battery charging system of claim 7, wherein the control device comprises a charging voltage monitoring unit, and the charging voltage monitoring unit monitors the charging voltage.

9. A battery charging method, comprising:
connecting an adapter to a battery;
providing a DC voltage to the battery to charge the battery by the adapter;
presetting multiple charging modes in a control device, and choosing a charging mode from the charging modes; and
controlling a charging current and a charging voltage of the adapter charging the battery according to the charging mode chosen by the control device.

10. The battery charging method of claim 9, wherein the charging modes comprises a normal charging mode, and the adapter charges the battery within a normal charging voltage and a normal charging current when the normal charging mode is chosen.

11. The battery charging method of claim 10, wherein the charging modes comprises a high power charging mode, the adapter charges the battery within the normal charging voltage and a first charging current when the high power charging mode is chosen, and the first charging current is smaller than the normal charging current.

12. The battery charging method of claim 10, wherein the charging modes comprises a long-life charging mode, the adapter charges the battery within a first charging voltage and the normal charging current when the long-life charging mode is chosen, and the first charging voltage is smaller than the normal charging voltage.

13. The battery charging method of claim 12, wherein the control device comprises a monitoring module, the monitoring module comprises a battery capacity monitoring unit, and the battery capacity monitoring unit monitors a power capacity of the battery, and the control device controls the adapter to work in the long-life charging mode when the power capacity of the battery is less than a threshold capacity.

14. The battery charging method of claim 13, wherein the monitoring module further comprises a battery charging times monitoring unit, the battery charging times monitoring unit monitors a number of times the battery has previously been charged, and the control device controls the adapter to work in the long-life charging mode when the number of times of previous charges is larger than a threshold times.

15. The battery charging method of claim 9, wherein the control device comprises a monitoring module, the monitoring module comprises a charging current monitoring unit, and the charging current monitoring unit monitors the charging current.

16. The battery charging method of claim 15, wherein the control device comprises a charging voltage monitoring unit, and the charging voltage monitoring unit monitors the charging voltage.
